(19) United States
(12) Patent Application Publication
(10) Pub. No.: US 2012/0202049 A1
(43) Pub. Date: Aug. 9, 2012

(54) TOUGHENED GLASS SPACER

(75) Inventors: Serge Valladeau, Drancy (FR); Xavier Brajer, Cormeilles En Parisis (FR)

(73) Assignee: SAINT-GOBAIN GLASS FRANCE, Courbevoie (FR)

(21) Appl. No.: 13/501,482

(22) PCT Filed: Oct. 18, 2010
(86) PCT No.: PCT/FR10/52209

§ 371 Date: Apr. 12, 2012

(30) Foreign Application Priority Data
Oct. 22, 2009 (FR) 0957432

(51) Int. Cl. B32B 17/06; C03C 12/00

(52) U.S. Cl. 428/325; 428/426; 501/33

(57) ABSTRACT

The invention relates to an object containing at least one glass spacer between a first element of said object and a second element of said object, said spacer having a concentration gradient in alkali metal ions from its surface and perpendicular to its surface. The object may be a solar collector under vacuum. The invention also relates to a glass bead having a concentration gradient in alkali metal ions from its surface and perpendicular to its surface and its use as a spacer withstanding a pressure force between two elements, said pressure pushing the two elements together.

The invention relates to the field of glass spacers. Spacers are used to maintain a distance between two solid elements, notably two generally parallel walls of an object such as double glazing, a flat lamp, a solar thermal collector etc.

Glass spacers are known. As documents of the state of the art, mention may be made of WO 96/12862 and U.S. Pat. No. 4,683,154. Spacers may be made of metal as well as a ceramic such as zirconia. The chemical toughening technique is known to reinforce glass objects in applications where glass is stressed in tension or when flexed, but not in compression. Glass spacers present the advantage of being hardly visible taking into account the natural transparency of glass. Moreover, they improve the energy efficiency of solar collectors, since they allow solar radiation to pass. Thus, for an application in a solar collector, the spacer is an element that is transparent, at least in wavelength regions of solar radiation that are used for the conversion of energy coming from solar radiation into thermal energy by means of absorption.

The idea has now occurred to treat glass spacers by chemical toughening for an application where they are stressed in compression, as is notably the case when the spacer separating two solid elements is under sub-atmospheric pressure. Glass spacers are relatively fragile and their employment in a production process or in operation in the final application generates breakages. In addition, for glazing under vacuum and flat collectors under vacuum, the necessary presence of spacers is associated with a loss of thermal performance by conduction. It is therefore advantageous to look for an increase in the mechanical strength of spacers in order to reduce their number.

It was not obvious from first principles that ionic exchange conferred by chemical toughening made it possible to obtain an improvement in the compressive strength of spacers, notably those in the form of a sphere. It is know by a person skilled in the art that ion exchange at a temperature below the Tg of glass may introduce compression in the surface layers of the treated glass, which reinforces it in the case where this is subject to tensile stress or to flexing stress, as is the case with cockpit glasses of aircraft for example. This surface compression due to ion exchange makes it possible to compensate in part for the stress applied to the surface which is a tension in the case of outer forces applied by tension or flexing. On the other hand, in the case where external forces are of compression or crushing, it is not obvious from first principles that ion exchange makes it possible to obtain reinforcement.

FR 2 103 574 teaches a chemical toughening treatment for grains with a view to increasing their tensile strength.

The spacer is placed between two elements (called the first and second element in which it is in contact) to be separated, such as two walls, for ensuring a distance between them. The space between the elements contains spacers and gas at atmospheric or reduced pressure or under vacuum. The free space between the elements (that is to say the free space in the immediate environment of the spacer) may thus be at sub-atmospheric pressure (pressure less than atmospheric pressure). The spacer according to the invention is notably recommended for any object comprising glazing under vacuum or at low pressure, for example flat lamps under vacuum, a solar collector under vacuum, an insulator under vacuum, (refrigerator door, a door of a dwelling, an oven door) etc. These objects in point of fact are subjected to pressure on account of the vacuum (atmospheric pressure) on their main faces, which directly or indirectly compresses the spacer. If the vacuum is produced between the two outer walls, the pressure exerted on each wall in the direction of the other is an atmosphere and therefore less than 1.2 bar. The internal pressure at the object typically lies between 1×10⁻⁸ bar and 1.2 bar. This external pressure may be transmitted to the spacer according to the invention via internal elements to the object the walls of which participate in the outer envelope. A solar collector generally comprises a glass as the first outer wall, which is designed to receive sunlight and a metal plate as the second outer wall (that may be incorporated in a metal casing) or one made of glass. This collector generally contains means of absorption through which a heat-carrying fluid passes, said means of absorption being heated by solar energy. The vacuum is generally created between these two outer walls. In this case, the spacers serve to prevent crushing due to the external pressure which is transmitted to them directly (the case where they are in contact with an outer wall) or indirectly (the case where other elements inside the object transmit pressure to them). The spacers according to the invention may be considered as being point spacers in as much as they do not participate in the outer envelope of the object. Moreover, the spacer may be compressed under the effect of supplementary forces, notably those due to flexing deformation of the object or those due to stresses of thermal origin or those due to the production process (in some cases, notably when the object has to be subjected to a laminating operation with PVB (polyvinyl butyral), it must additionally support the pressure of the autoclave).

Thus, the invention relates to an object comprising at least one glass spacer between a first element of said object and a second element of said object, said spacer having a concentration gradient in alkali metal ions, from its surface and perpendicular to its surface. Notably, the first element may be a glass wall. Notably, the glass of this wall may contain less than 200 ppm of iron. This is useful when the glass is required to allow the maximum solar radiation to pass.

The method of reinforcement used for spacers according to the invention aims, by ion exchange (also called “chemical toughening”), at replacing ions initially present in the glass with larger ions, with the aim of inducing compressive stress forces on the surface. This technique is itself known to a person skilled in the art. For this chemical toughening treatment, the glass should contain an alkali metal oxide before said toughening. This oxide may be Na₂O or Li₂O and be present in the glass in an amount of, for example, 1 to 20% by weight. Chemical treatment of glass consists of replacing the alkali metal ions initially in the glass with other larger metal ions. If the initial oxide is Na₂O, chemical toughening is applied by treatment with KNO₃, so as to replace, at least partially, the Na⁺ ions with K⁺ ions. If the initial oxide is Li₂O, chemical treatment is applied by treating with NaNO₃ or with KNO₃ so as to replace, at least partially, Li⁺ ions according to the case with Na⁺ ions or K⁺ ions. Chemical toughening leads to a concentration gradient in alkali metal ions (notably K⁺ or Na⁺) perpendicular to the treated surfaces and decreasing for one of the ions from said surface and increasing for another alkali metal ion when proceeding from the core of the glass to the surface. This exchange in alkali metal ions exists from any point of the chemically treated surface of the spacer. Thus, “alkali metal ion gradient” is understood to mean that the concentration in an ion (exchanger ion) diminishes from the surface proceeding in the direction of the core, while the concentration in another ion (exchanged ion) increases from the surface proceeding in the direction of the core. The exchanger ion and the exchanged ion form a pair. In the case of sodium/potassium exchange, exchange is carried out by dipping spacers into a bath of potassium salt brought to temperatures of between 390 and 500° C. Within the context of the present invention, the exchange parameters (temperature and duration) are chosen so as to promote a high surface stress and a relatively low exchange depth for chemical toughening. The intensity of the surface stress is thus favored to the detriment of the exchange depth. Conventionally, the exchange depth p is such that after chemical toughening
Cₚ is the concentration in exchanger ion at depth p,
C_{c} is the concentration in exchanger ion at the core of the glass (corresponding then to the concentration in exchanger ion in the glass before chemical toughening, it being possible for this concentration to be zero),
C₀ is the concentration of exchanger ion at the surface of the glass, while

$$\frac{{C}_{p} - {C}_{c}}{{C}_{0} - {C}_{c}} = 0.05$$

In other words, the exchange depth is the depth at which the excess concentration in exchanger ion is no more than 5% of its value at the treated surface (excess concentration: additional concentration compared with the initial concentration).

To this end, it is preferred to carry out chemical toughening at a relatively low temperature. For example, in the case of the exchange of Na⁺ ions by K⁺ ions (toughening of the glass in a bath of potassium nitrate), the temperature for chemical toughening may be chosen as between 350 and 420° C. Ion exchange may or may not be assisted by an electric field. The use of an electric field accelerates exchange, which makes it possible to obtain higher surface stress and exchange depth, or a shorter treatment period. On the other hand, it introduces asymmetry in the spacer treatment. In this way, some surface zones may be more chemically toughened than others. Without being exclusive, the use of an electric field does not however appear to be necessary. The non-utilization of an electric field promotes identical treatment over all the surface of the spacer and thus the achievement of an identical alkali metal ion gradient starting from any point of the surface in the direction of the core of the spacer.

Within the context of the invention, the depth of alkali metal ion exchange may lie between 1 micron and 20 microns, and preferably 5 to 17 microns.

Ion exchange may be carried out from liquid or pasty molten salts containing the ion that it is desired to diffuse into the glass. Such salts are for example sodium or potassium nitrate or sulfate or chloride or mixtures of these compounds.

Generally, the starting glass contains:
50 to 80% by weight of SiO₂,
5 to 25% by weight of alkali metal oxide, preferably chosen from Na₂O and K₂O, preferably Na₂O in a large quantity (which may then extend up to 25% by weight) within the context of Na/K exchange
1 to 20% and preferably 4 to 10% by weight of alkaline earth oxide, preferably CaO.

The glass may contain at least one other oxide and notably Al₂O₃ and/or B₂O₃.

For an application in a solar collector, the starting glass (and thus also the final glass) contains less than 200 ppm by weight of iron oxide (sum of all forms of iron oxide).

It will be noted that the starting glass contains CaO, while usually glasses intended to be chemically toughened have little or no CaO.

As an example, the starting glass (before chemical toughening) may comprise:

| | 2 mm ± 7 μm beads |
|---|---|
| SiO₂ | 67.5% by weight |
| Na₂O | 10.5% by weight |
| K₂O | 5.5% by weight |
| BaO | 3.8% by weight |
| CaO | 5.8% by weight |
| B₂O₃ | 0.1% by weight |
| Al₂O₃ | 0.6% by weight |
| Fe₂O₃ | 0.02% by weight |

As regards alkali metals, it is preferred to work with the Na/K pair for chemical toughening (exchange of Na⁺ ions at the start in the glass by K⁺ ions at the start in the chemical toughening bath) rather than on the Li/Na pair (exchange of Li⁺ ions at the start in the glass by Na⁺ at the start in the chemically toughening bath) since this last pair risks bringing about instability if the glass has to be heated when the spacers are employed (such as the final heat sealing of the solar collector with the aim of putting the interior under vacuum). By using the Na/K pair it is possible to employ spacers according to the invention up to approximately 400° C., notably between 100 and 400° C. without too great a loss of reinforcement provided by chemical toughening. In point of fact, the application may involve heating in order to hermetically seal two parts of a solar collector (for example) and subsequently to be able to form a vacuum.

With the same idea in mind, the presence of CaO in the starting composition is preferred since this oxide slows ion diffusion. Thus, in spite of the fact that its presence is not desired by a person skilled in the art since it is reputed to impede chemical toughening, it is desired within the context of the invention since it in fact stabilizes the ion gradient in the surface for the case where spacers have to be heated during their employment.

Overall, the composition of the spacer does not really change by chemical toughening since this treatment only produces an exchange of alkali metal ions at the surface and over a quite moderate depth.

It may then be said that the spacer according to the invention comprises:
50 to 80% by weight of SiO₂,
5 to 25% by weight of an alkali metal oxide,
1 to 20% and preferably 4 to 10% by weight of an alkaline earth oxide, preferably CaO.

The spacer may have any suitable form: parallelepiped, cross-shaped, sphere-shaped (case of a bead), etc. The spherical form is particularly preferred for several reasons:
the area in contact with the spaced walls is reduced to a minimum, limiting thermal and electrical exchanges by thermal or electrical conduction from one wall to the other,
the spherical form enables spacers to roll, which provides considerable ease of conveyance in the production process,
the spherical form is less visible to the eye.

Before chemical toughening, the spacer generally has the form desired in the final application, since it is in point of fact recommended that it should not be considered necessary to cut it. In point of fact, a chemically toughened glass cannot usually be cut by conventional techniques or a cut-off wheel without the risk of uncontrolled breakage.

Spacers may be glued to at least one of the elements with which they have to be in contact. This gluing may intervene at the same time as sealing and applying a vacuum. In particular, in the case of spacers under vacuum, the spacers may be secured (gluing) to means of absorption prior to being put under vacuum.

The beads generally have a diameter between 0.4 mm and 15 mm. A small diameter of 1 to 5 mm is well suited and makes it possible to produce an object according to the invention that is thin. This is an appreciable advantage when the object is intended to be incorporated in a roof as is the case of a solar collector.

In the case of glass beads of the prior art (without chemical toughening) that have to be placed between two walls under vacuum, at least 1000 beads per m² are generally placed between the two walls, notably in the case where the object has to pass into an autoclave.

Chemical toughening according to the invention enables this number to be divided by 4, which is accompanied by an improvement in production yields. Thus, notably between 200 and 1000 beads according to the invention per m² (of course relative to the area of only one of the walls) may be placed between the two elements conveying pressure to them. More than 250 per m² may also be placed. Less than 800 per m² may also be placed. Thus, according to the invention, one of the elements may be flat and the object may include between 200 and 1000 spacers per m² of said flat element. Moreover, in the case of insulating units under vacuum and flat solar collectors under vacuum, the use of chemically toughened spacers according to the invention brings about, on account of the fact of a possible reduction in their number, a considerable reduction (sometimes by a factor of 4) in the loss of thermal performance due to the necessary presence of spacers.

The invention also relates to the use of a bead according to the invention as a spacer for withstanding a pressure force between two elements, pushing them together.

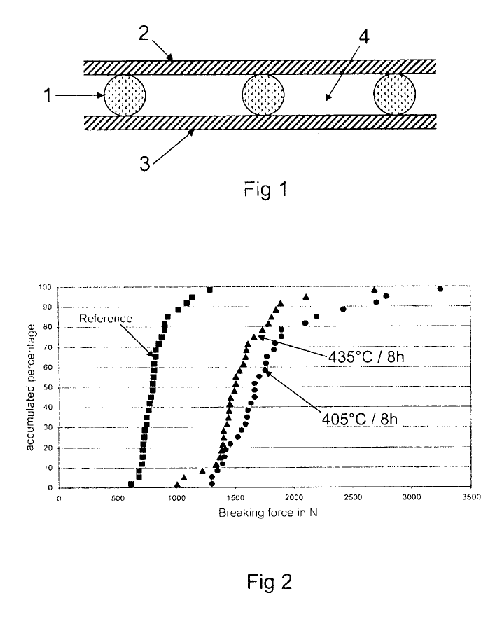

FIG. 1 shows glass beads 1 according to the invention acting as a spacer between two elements 2 and 3 that are glass sheets acting as outer walls, the vacuum being applied in 4 between the two glass sheets.

FIG. 2 shows the percentage of accumulated breakages as a function of the breaking force (compressive force) in the case of glass beads with a diameter of 2 mm, chemically toughened in two different ways compared with untreated beads (reference).

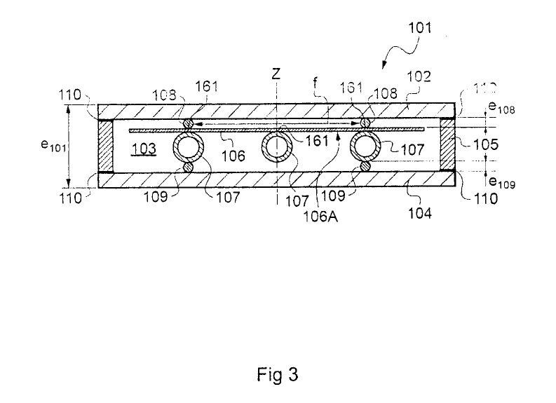

FIG. 3 is a section through a solar collector 101 as the object according to the invention. The solar collector 101 comprises a first transparent upper outer wall 102 and an equally transparent lower outer wall 104, formed of two identical glass plates made of heat-toughened glass. The walls 102 and 104 delimit, between them and with a metal frame 105 to which they are attached by a leak-proof sealing joint 110, a leak-proof housing 103 for receiving the means of absorption 106 and 107 of the collector. The outer envelope of the object according to the invention is thus formed of the walls 102, 104, 105. The means of absorption comprise an absorber panel 106 and a duct 107 for the circulation of the heat-carrying fluid. The channel 107 is in thermal contact with the absorber panel 106 beside the lower face 106A thereof. The collector 101 comprises a plurality of upper spacers 108 according to the invention and a plurality of lower spacers 109 according to the invention intended to maintain a constant distance between the upper wall 102 and the lower wall 104 when the collector 101 is put under vacuum. These spacers 108 and 109 are aligned in pairs in the direction Z of the thickness of the collector 101, so that each upper spacer 108 is positioned between the upper wall 102 and the part 161 of the absorber panel 106 that is in thermal contact with the duct 107, while each lower spacer 109 is positioned between the lower wall 104 and the duct 107. The spacers 108 and 109 are in the form of glass beads connected to the walls 102 and 104, for example by gluing. In order to withstand the compressive force exerted on the walls 102 and 104 when a vacuum is applied in the housing 103, the glass beads are reinforced by chemical toughening according to the invention. The pressure being exerted on the outer walls 102 and 104 is in point of fact transferred to the spacers 108 and 109 via internal elements of the solar collector, the means of absorption 106 and 107. Chemical toughening makes it possible to increase significantly the compressive strength of the beads acting as spacers.

### EXAMPLES

Glass beads were used corresponding to those described in table 1. A sodium/potassium ion exchange was carried out on these beads by toughening in a bath of molten potassium nitrate at 405° C. for 8 hours.

The operating protocol for toughening 100 beads 2 mm in diameter was as follows:
weighing 100 beads,
introducing the beads onto a sample holder,
putting the sample holder in place in a bath of molten potassium nitrate placed in an oven at the desired temperature (405° C. or 435° C. according to the tests),
agitating the sample carrier every hour for 8 hours,
removing from the sample holder,
washing with dematerialized water,
weighing 100 beads and determining the gain in weight for checking ion exchange, and any re-toughening in the bath in order to continue chemical toughening, if necessary.

In the case of an eight hour treatment at 405° C., the gain in weight was 0.06% and the exchanged depth measured by a scanning electron microscope was approximately 5 μm.

The beads treated in this way were subjected to a compression test of which the results are shown in FIG. 2. The percentage of accumulated breakages was traced as a function of the force at break (compressive force).

It will be seen that chemical toughening treatments made it possible to increase significantly (by more than 500 N) the mean values for breakages of beads. The use of these chemically reinforced beads as a spacer in flat lamps (between two glass sheets separated by a vacuum) showed an appreciable reduction in the number of breakages of these beads during the production process, appreciably increasing the production yield. In addition, in the case of flat lamps, the number of spacers necessary had to be divided by four. In the case of non-chemically treated beads, the production yield was 85%, while it was 95% with the same beads chemically treated according to the invention.

1. An object comprising a glass spacer between a first element of said object and a second element of said object, said spacer having a concentration gradient in alkali metal ions from its surface and perpendicular to its surface.

2. The object of claim 1, wherein the spacer is in the form of a sphere.

3. The object of claim 2, wherein one of the first element and the second element is a flat element comprising between 200 and 1000 spacers per m² of said flat element.

4. The object of claim 1, wherein an exchange depth in alkali metal ions lies between 1 micron and 20 microns.

5. The object in claim 1, wherein the first element is a wall made of glass.

6. The object of claim 5, wherein the glass of the wall comprises less than 200 ppm by weight of iron oxide.

7. The object of claim 5, wherein the wall made of glass is a wall of an outer envelope of the object.

8. The object of claim 1, wherein the concentration gradient exists from any point of the surface and in a direction of a core of glass of the spacer.

9. The object of claim 1, wherein the object comprises two or more spacers and a free space around the spacers is at sub-atmospheric pressure, such that atmospheric pressure exerted on the object is transferred to the spacers.

10. The object of claim 1, in the form of a solar collector.

11. The object of claim 1, wherein glass of the spacer comprises less than 200 ppm of iron oxide.

12. A glass bead having a concentration gradient in alkali metal ions from its surface and perpendicular to its surface.

13. The glass bead of claim 12, comprising a glass comprising less than 200 ppm of iron oxide.

14. The glass bead of claim 13, wherein the glass comprises 50 to 80% by weight of SiO₂, and 5 to 25% by weight of a alkali metal oxide.

15. A spacer comprising the glass bead of claim 12, wherein the spacer withstands a pressure force between two elements, such that said pressure is pushing the two elements together.

16. The glass bead of claim 13, wherein the glass comprises 50 to 80% by weight of SiO₂, 5 to 25% by weight of a alkali metal oxide and 1 to 20% by weight of an alkaline earth oxide.

17. A spacer comprising the glass bead of claim 13, wherein the spacer withstands a pressure force between two elements, such that said pressure is pushing the two elements together.

18. A spacer comprising the glass bead of claim 14, wherein the spacer withstands a pressure force between two elements, such that said pressure is pushing the two elements together.

19. A spacer comprising the glass bead of claim 16, wherein the spacer withstands a pressure force between two elements, such that said pressure is pushing the two elements together.
